(19) United States
(12) Patent Application Publication
(10) Pub. No.: US 2005/0135863 A1
(43) Pub. Date: Jun. 23, 2005

(54) Marking pen and protective cap therefor

(76) Inventor: William G. Allemann, St. Louis, MO (US)

Correspondence Address: Norman L. Wilson, Jr., P.O. Box 270448, St. Louis, MO, 63126, US

(21) Appl. No.: 10/739,981

(22) Filed: Dec. 19, 2003

(51) Int. Cl. B43K 23/02

(52) U.S. Cl. 401/131; 401/7

(57) ABSTRACT

The plastic caps of conventional marking or highlighting pens fit securely in order to prevent evaporation. During use the marking pen's cap becomes an annoyance. Often users lay the cap aside while concentrating on material being read. They then have difficulty in locating it. It is also aggravating to manage the marking pen cap while maintaining a grasp on reading material. Herein the marking pen cap is provided with an outwardly projecting attachment. The attachment is so structured that it is capable of being retained between two fingers of a user in such a way that the user can, with the same hand, maintain an effective grasp of another object.

### CROSS-REFERENCES TO RELATED APPLICATION

There are-no applications related to this application.

### FIELD OF THE INVENTION

This application relates to liquid applicators and, especially to absorbent-tipped or wick-tipped liquid applicators known to those skilled in the art as marking or highlighting pens. Marking pens, and in particular highlighting pens, are a very popular writing instrument for business and personal use. They can be found in the hands of almost every student in the study halls of high schools and colleges for use in highlighting textbook passages and other printed materials.

### BACKGROUND OF THE INVENTION

Liquid applicators or marking devices typically consist of three parts: (1) an ink-containing shaft, barrel, or marker portion, having a closed bottom and an open top, (2) a wick-like tip secured in the open top, and (3) an airtight cap which snaps or press fits tightly onto the barrel portion to prevent the tip from air drying. In addition to the absorbent applicator tip or wick, conventional liquid applicator marker barrels frequently include a fluid reservoir. In some applicators the fluid in the reservoir is free to slosh around. By “wick-like” we mean that the fluid in the barrel portion is absorbed in a matrix of material such as nylon or felt which delivers fluid to the tip by capillary action. The preferred inks employed in highlighting marker pens utilize a fluorescent dye that gives the ink a pleasing glow-like appearance when it is applied to the paper. The marking tip is generally larger and wider than tips employed in ballpoint writing pens. Marking pens usually have tips between about one-sixteenth to three-eights inch in width.

Conventional marking pens are not without certain deficiencies. Contributing to such deficiencies is the inherent nature of marking instruments. The exposure of the marking tip to the atmosphere causes rapid evaporation of ink from the felt tip material. The resultant drying of the tip material blocks the flow of fresh ink to the tip. Undesired evaporation of the volatile colorant not only depletes the liquid supply in the body of the reservoir, but it often leaves a hard residue on the surface of the applicator tip. One deficiency, then, is the need to tightly cover the marker tip of marking instruments. Another deficiency is the troublesome task of dealing with the cap in order to replace it frequently while using the marking pen.

Referring, now more specifically to these deficiencies, the plastic caps of markers securely fit over the tip or nib in order to prevent evaporation. However, often, during the course of use, the user will forget to recap the applicator. Frequently the user may leave the cap off the applicator during a long period of use rather than bothering to recap it because of the inconvenience of holding the cap. While marking a series of objects intermittently, or while only periodically highlighting passages of text for future reference, the user of the marking pen should repeatedly remove and replace the marker cap. To do so, some users hold the marker cap in their mouths. Other marking pen users lay the cap aside rather than periodically replacing it. Still other users carelessly cast the tip cap aside so that when it is time to replace it they have difficulty in locating it. This is easy to do, and particularly annoying when the user is concentrating on the material being highlighted. In addition to drying, longer than necessary uncapped periods contribute to reducing the pliability and absorbency of the felt tip.

Readers also often find it necessary to highlight text while not seated at a desk or table, or they may wish to read while casually relaxing or even lying down. A common example is reading and highlighting while in bed. When so doing it is quite aggravating to manage the cap in order to replace it and to maintain a grasp on the reading material when not highlighting.

Several patents can be found in the U.S. patent art directed to overcoming the deficiencies just discussed. One means for keeping track of a marking pen cap is disclosed in Ewing patents U.S. Pat. No. 6,626,334 and U.S. Pat. No. 6,264,080. Ewing designed a marking stick which can be inserted into a cap capable of being carried on the body of a user. In other words the cap is fabricated to be to be clipped to a pocket or belt while the marking portion of the device is in use. The marking portion or stick can then be inserted in the cap when it is not used, and can be withdrawn from the cap when it is desired to use the stick for marking purposes.

In two patents the cap problem is dealt with by rendering the felt marker tip retractable. Burwell, in U.S. Pat. No. 5,174,814, discloses a marker pen that includes a compression spring which fits in back of a shoulder in the pen body and in front of another shoulder in the cartridge assembly. The cartridge assembly carries an integrally formed, cantilevered retract arm and a retracting button. When the user wishes to retract the cartridge a clip is depressed pushing down on the button so that the compression spring causes the retraction of the cartridge.

U.S. Pat. No. 6,033,141 to Blaustein also discloses a retractable sealed marking instrument The capless retractable marking instrument of that invention includes an ink-impregnated marker cartridge. A marker carrier mechanism is connected to the marker cartridge to linearly advance and retract the marker cartridge within the marker casing.

Two additional patents are directed to self capping marking pens. In U.S. Pat. No. 5,352,053 to Reitze a writing instrument is disclosed having a slidably and pivotably disposed cap for covering the writing tip. A pivot means pivotably and slidably positions the cap arm along the cylindrical body to open and closed positions.

In U.S. Pat. No. 3,945,734 to Woodbridge an absorbent tipped liquid applicator apparatus is equipped with a mechanism for selectively capping and uncapping its tip in response to manual pressure. When the retractor means is squeezed, it opens up the end of a sleeve and withdraws the tip.

It can be seen that the prior art recognizes and deals with a long-standing desire to produce a marking pen devoid of marker tip inadequacies. The patents described illustrate that there is a genuine need for a means for managing the assembly of a marking pen and its cap. Marking pen bottoms have been provided with cavities to accept the cap, but these too are not completely satisfactory. The caps are readily dislodged because they generally are not tightly held. Both hands are required to press the cap into the bottom receptacle, causing difficulty for the user in maintaining a grasp of the reading material. Hence there is still room for improvement, particularly less complex and less expensive solutions to preventing the moisture in the marker nib and in the cartridge from dehydration than those in the prior art.

### SUMMARY OF THE INVENTION

The invention herein is directed to improved liquid applicators of the type which includes an elongated liquid-containing reservoir body provided with a closed bottom, a top opening, and a wick-like tip secured in the top opening. The most-used example of such applicators is a marking pen. It is to be understood that in order to prevent evaporation of ink from the felt tip material such liquid applicators should be capped by their users during periods of non-use. To manage such capping a more reliable means is needed. The means provided herein does include a tight fitting cap encasing the wick-like tip. Herein, that cap is provided with a cap attachment projecting outwardly therefrom. This cap attachment is so structured that it is capable of being retained between two fingers of a user in such a way that the user can, with the same hand, maintain an effective grasp of another object such as a book.

For an understanding of how the cap attachments herein are structured a description of various cap attachments in conjunction with the accompanying drawings will be helpful.

### BRIEF DESCRIPTION OF THE DRAWINGS

FIG. 1 is a perspective view illustrating the use of this invention.

FIG. 2 is a perspective view showing a marking pen that can utilize the cap of this invention.

FIG. 3 is a diagrammatic view of one form of cap attachment.

FIG. 4 is a diagrammatic view of a different form of cap attachment.

FIG. 5 is a diagrammatic view of another form of cap attachment.

FIG. 6 is a diagrammatic view of still another form of cap attachment.

FIG. 7 is an exploded view showing both a marking pen and a cap.

FIG. 8 is an elevation view cross hatched to show the cap

FIG. 9 is a perspective view showing a hand carrying a cap.

FIG. 10 is a diagrammatic view showing a different means of attaching the cap attachment.

FIG. 11 is a diagrammatic view showing an elastomeric cap attachment.

FIG. 12 is a diagrammatic view of a hexahedral cap attachment.

FIG. 13 is a diagrammatic view of a cap attachment which is not integral with the cap.

### DESCRIPTION OF THE INVENTION

The liquid applicators within the purview of this invention will generally be conventional off-the-shelf marking pens obtainable in any department, variety, or stationery store. Such marking pens include an elongated liquid-containing tank or reservoir body and a wick-like tip. The tank portion has no opening in the bottom. The wick-like tip is secured in a top opening through which the fluid has been admitted. Usually the fluid is an aqueous or nonaqueous solution, for example, a dye dissolved in a volatile solvent, and sometimes in a glycol and water mixture. The tips of these marking instruments typically are felt, plastic or fibrous materials such as nylon, acrylic or polyester fiber.

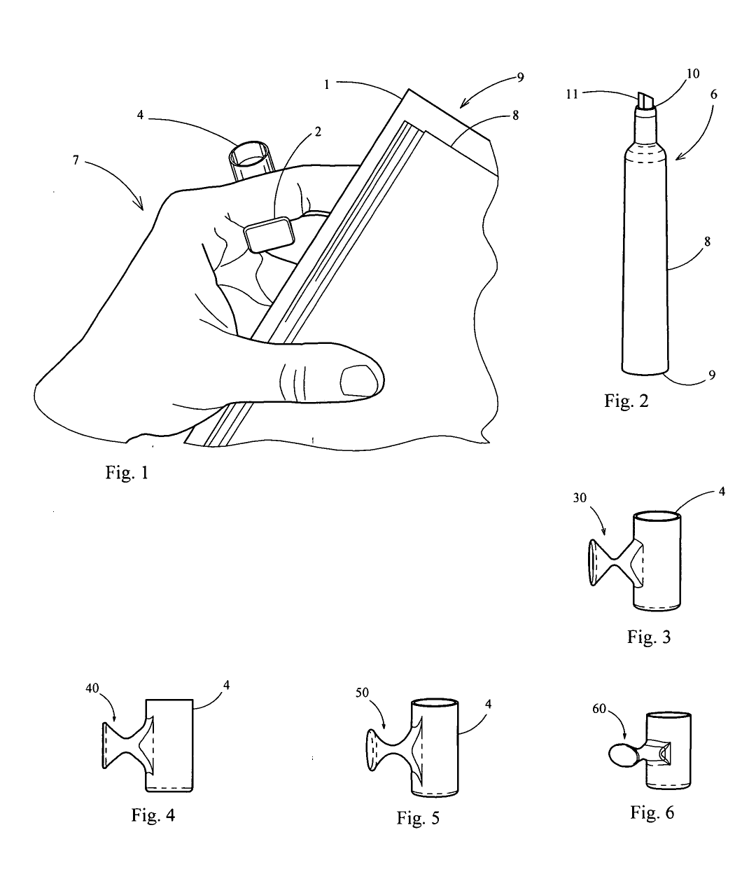

It has been found that retention of a marking pen cap between fingers can be accomplished with a structure provided with a relatively narrow section between two wider sections. Such a structure is the most comfortable to a person's hand. The essence of this invention, then, is the provision, for such marking pens, of a cap therefor having an attachment projecting therefrom as an appendage which fits comfortably between one's fingers. This appendage, extending from the cap, can be held between two fingers, as a means for supporting the cap attached thereto. This can best be visualized by referring to FIG. 1. In FIG. 1, cap attachment 2 is a spool-shaped appendage projecting from cap 4 of a marking pen 6 (not seen in FIG. 1). A typical marking pen is illustrated in FIG. 2. This marking pen 6, or other liquid applicator, includes an elongated liquid-containing reservoir body 8 having a closed bottom 9, a top opening 10, and a wick-like tip 1 1 secured in that top opening. The tight fitting cap 4 encases the wick-like tip 11 to prevent it from drying out as previously explained herein. Returning to FIG. 1, the cap attachment 2 projecting from cap 4 is a structure adapted to be held by two fingers of hand 7. This renders hand 7 available for accompanying activities such as turning pages 8 of a book 9 while holding and keeping track of marking pen cap 4. The other hand is, of course, available for highlighting or for otherwise using the marking pen.

Desirably the projecting cap attachment is a spool-shaped solid without an axial hole passing through it. A spool is essentially a cylinder whose top and bottom circumferences are larger than the circumference of the cylindrical mid-portion of the cylinder between its top and bottom. Stated differently, a cylinder, geometrically, is a solid whose cross-section at any point between its top and bottom is a circle. “Spool-shaped” means that in a spool, the diameters of the circles between the top and bottom are less than the diameters of the top and bottom circles. Essentially that is the shape of the projecting cap attachment contemplated by this invention.

For its use herein it is desirable to shape a spool for a comfortable fit between fingers. This is accomplished by collapsing the mid-portion of the cylinder even more. Again in terms of the cross-section, the circumferences of the circles between the top and bottom of the cylinder gradually decrease for a certain distance from the top and then gradually increase to its bottom circular circumference. The result is a cylinder with a narrow mid-section. By mid-section we mean the portion of a cylinder between the cylinder's top and its bottom. This will become more clear by considering the geometrical and mathematical definitions of such cylindrical solids. The geometrical shapes of the projecting cap attachments will be illustrated in the figures in the drawing.

Cap attachments projecting from marking pen caps as contemplated herein are quadratic surfaces in the form of solids of revolution. Representative examples of such geometric solids, illustrated in the drawings, will now be described.

In FIG. 3 marking pen cap 4 is shown with projecting cap attachment 30 in the form of a quadratic surface. The quadratic surface is a double cone for which an algebraic equation is known. A double cone is a geometric solid formed by two cones placed apex to apex as shown in FIG. 3.

In FIG. 4 the projecting cap attachment of marking pen cap 4 is represented by the numeral 40. The projecting quadratic surface is a hyperboloid. This hyperboloid can be represented by a Cartesian equation in combination with a parametric equation.

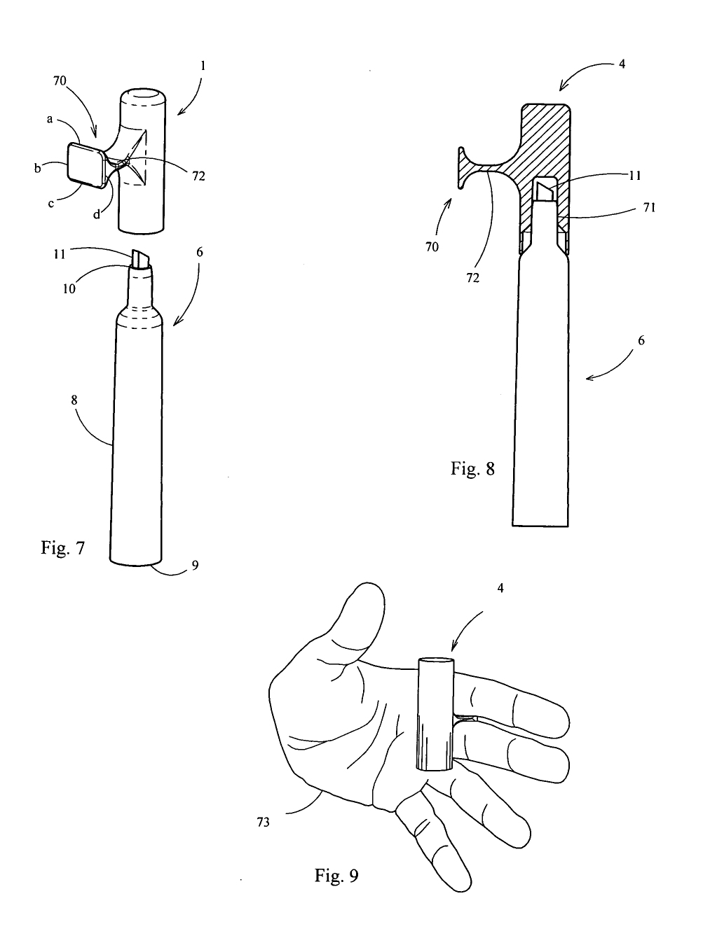

A catenoid is a catenary of revolution resembling a hyperboloid with a shorter mid-section. A helicoid can be continuously deformed into a catenoid. A cap attachment 50 in the form of a catenoid is shown attached to a marking pen cap 4 in FIG. 5. This surface of revolution can be expressed by a known parametric equation.

In FIG. 6 cap attachment 60 is an elliptic hyperboloid. This elliptic hyperboloid has the same Cartesian equation as the hyperboloid of FIG. 4, but a different parametric equation.

### PREFERRED EMBODIMENT OF THE INVENTION

The preferred embodiment of the invention is shown in FIGS. 7 and 8. The combination of the marking pen with the cap is illustrated in these two figures. In FIG. 8 the liquid applicator or marking pen 6 is again depicted. As previously described the applicator, includes an elongated liquid-containing reservoir body 8 with a closed bottom 9, and a top opening 10. The wick-like tip 11 is held in top opening 10 so that it can extend down into the liquid in the reservoir body as is known in the art. In FIG. 8 cap 4 is shown in cross-section in order to illustrate that a snap fit at 71 prevents wick 11 from drying out.

Referring now to the preferred cap attachment of this invention, it is noted that cap attachment 70 illustrated in FIGS. 7 and 8 is, in effect, a truncated spool-shaped solid. The resulting truncation yields flat sides a, b, c, and d, but the narrow mid-portion 72 (FIG. 8), fitting between the fingers, remains.

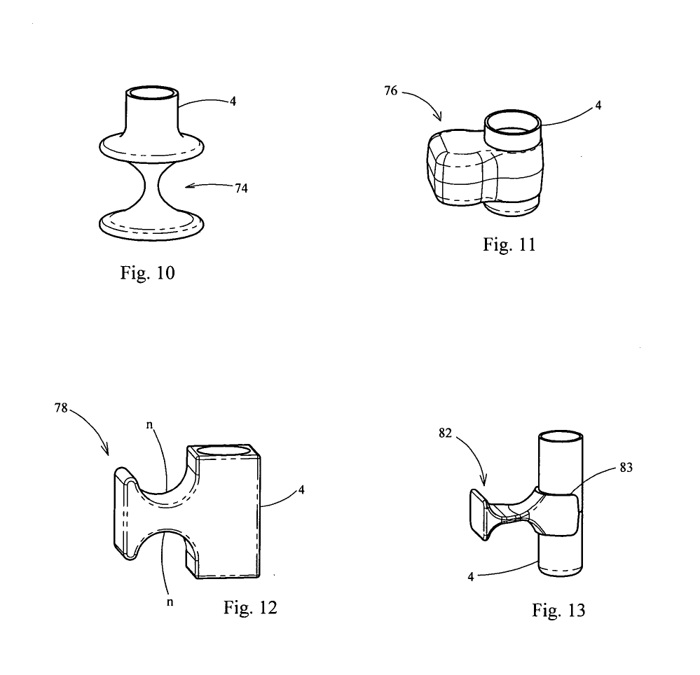

In the light of the foregoing description variations and modifications of the invention will occur to those working in the field. As an example, the projecting cap attachment need not be integral with the cap in the sense that it is molded with the cap during the manufacturing process. As can be seen in FIG. 13 cap attachment 82 is provided with a band 83 which can partially or completely surround cap 4 in a locking taper fit. The cap attachment can, thus, be provided for marking pens as a separate component. Those in this art will recognize that whereas the most important use for the invention will be marking pens, liquid glues and shoe polishes are also stored and applied from such wick-containing applicators, in which case the wicks will be somewhat wider. In addition, in FIG. 1 the cap, 4, is shown supported on the back of the hand. Nevertheless, the cap 4 can be held inside the hand as seen in FIG. 9. As another ramification, previously the cap attachment has been shown attached to cap 4 so as to project outwardly from the cap at an angle. However, the cap attachment can also be attached to cap 4 so as to project axially therefrom as illustrated in FIG. 10. As a further modification the cap attachment can be fabricated using an elastomeric material as shown in FIG. 11. As illustrated in that figure cap attachment 76 is a pliable material that is deformed by the user's fingers into the shape of its rigidly molded equivalent. As still another variation, instead of a cylinder, the cap attachment can be fabricated from a hexahedron such as a cube. An attachment having a square cross-section is shown at 78 in FIG. 12. Consistent with the invention, the top and bottom cross-sections of the hexahedron are larger than the cross-sections at the mid-portion n of the hexahedron between its top and bottom. Such ramifications and modifications are deemed to be within the scope of this invention.

1. The combination of: a liquid applicator which includes an elongated liquid-containing reservoir body having a closed bottom, a top opening, and a wick-like tip secured in the top opening; with: a tight fitting cap encasing the wick-like tip, the cap having a cap attachment projecting outwardly therefrom, the cap attachment being so structured that it is capable of being retained between two fingers of a user's hand in order to free that hand for other usage.

2. The combination of claim 1 wherein the cap attachment is a cylinder whose top and bottom circumferences are larger than the circumference of the cylindrical mid-portion of the cylinder between its top and bottom.

3. The combination of claim 1 wherein the liquid applicator is a marking pen.

4. The combination of claim 2 wherein the cap attachment is a double cone.

5. The combination of claim 2 wherein the cap attachment is a catenoid.

6. The combination of claim 2 wherein the cap attachment is hyperboloid.

7. The combination of claim 2 wherein the cap attachment is an elliptic hyperboloid.

8. The combination of claim 2 wherein the cap attachment is an appendage projecting from the marking pen cap at an angle.

9. A cap attachment adapted to be affixed to, as a projection from, a cap for a liquid applicator of the type having an elongated liquid-containing reservoir body, a top opening, and a wick-like tip secured in the top opening, the cap attachment being a geometric solid provided with a narrow section between two wider sections yielding a structure that it is capable of being retained between two fingers of a user's hand in order to free that hand for other usage.

10. The cap of claim 9 wherein the cap attachment is tetrahedron whose top and bottom cross-sections are larger than the cross-sections at the mid-portion of the tetrahedron between its top and bottom.

11. The cap of claim 9 wherein the cap attachment is a cylinder whose top and bottom circumferences are larger than the circumference of the cylindrical mid-portion of the cylinder between its top and bottom.

12. The cap of claim 9 wherein the cap attachment is a truncated cylinder whose top and bottom circumferences are larger than the circumference of the cylindrical mid-portion of the cylinder between its top and bottom.

13. The cap of claim 9 wherein the cap attachment, having been fabricated with the cap, is an integral part of the cap.

14. The cap of claim 9 wherein the cap attachment is affixed to the cap.
